(19) United States
(12) Patent Application Publication
(10) Pub. No.: US 2002/0148169 A1
(43) Pub. Date: Oct. 17, 2002

(54) Composition for metal CMP with low dishing and overpolish insensitivity

(75) Inventors: Lizhong Sun, San Jose, CA (US); Shijian Li, San Jose, CA (US); Fred C. Redeker, Fremont, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/117,272

(22) Filed: Apr. 3, 2002

Related U.S. Application Data
(63) Continuation of application No. 09/543,777, filed on Apr. 5, 2000, now abandoned.

(51) Int. Cl. C09C 1/68; C09K 3/14

(52) U.S. Cl. 51/309; 106/3

(57) ABSTRACT

Polishing compositions for metal CMP with reduced dishing and overpolish insensitivity are formulated to have a low static etching rate at high temperatures, e.g., higher than 50° C. Embodiments include abrasive-free polishing compositions comprising one or more chelating agents, one or more oxidizers, one or more corrosion inhibitors, one or more acids to achieve a pH of about 3 to about 10 and deionized water.

### TECHNICAL FIELD

The present invention relates generally to metal polishing and, particularly, to planarizing copper (Cu) and/or Cu alloy metallization in manufacturing semiconductor devices with reduced dishing and overpolish insensitivity. The present invention is applicable to manufacturing high speed integrated circuits having submicron design features and high conductivity interconnect structures with improved reliability.

### BACKGROUND ART

The escalating requirements for high density and performance associated with ultra large scale integration semiconductor wiring require responsive changes in interconnection technology. Such escalating requirements have been found difficult to satisfy in terms of providing a low RC (resistance and capacitance) interconnect pattern, particularly wherein submicron vias, contacts and conductive lines have high aspect rations imposed by miniaturization.

Conventional semiconductor devices comprise a semiconductor substrate, typically doped monocrystalline silicon, and a plurality of sequentially formed interlayer dielectrics and conductive patterns. An integrated circuit is formed containing a plurality of conductive patterns comprising conductive lines separated by interwiring spacings, and a plurality of interconnect lines, such as bus lines, bit lines, word lines and logic interconnect lines. Typically, the conductive patterns on different layers, i.e., upper and lower layers, are electrically connected by a conductive plug filling a via hole, while a conductive plug filling a contact hole establishes electrical contact with an action region on a semiconductor substrate, such as a source/drain region. Conductive lines are formed in trenches which typically extend substantially horizontal with respect to the semiconductor substrate. Semiconductor “chips” comprising five or more levels of metallization are becoming more prevalent as device geometries shrink to submicron levels.

A conductive plug filling a via hole is typically formed by depositing an interlayer dielectric on a conductive layer comprising at least one conductive pattern, forming an opening through the interlayer dielectric by conventional photolithographic and etching techniques, and filling the opening with a conductive material, such as tungsten (W). Excess conductive material on the surface of the dielectric interlayer is typically removed by chemical mechanical polishing (CMP). One such method is known as damascene and basically involves forming an opening in the dielectric interlayer and filling the opening with a metal. Dual damascene techniques involve forming an opening comprising a lower contact or via hole section in communication with an upper trench section. The entire opening is filled with a conductive material, typically a metal, to simultaneously form a conductive plug in electrical contact with a conductive line.

Cu and Cu alloys have received considerable attention as a candidate for replacing Al in interconnect metallizations. Cu is relatively inexpensive, easy to process, and has a lower resistivity than Al. In addition, Cu has improved electrical properties vis-à-vis W, making Cu a desirable metal for use as a conductive plug as well as conductive wiring.

An approach to forming Cu plugs and wiring comprises the use of damascene structures employing CMP. However, due to Cu diffusion through interdielectric layer materials, such as silicon dioxide, Cu interconnect structures must be encapsulated by a diffusion barrier layer. Typical diffusion barrier metals include tantalum (Ta), tantalum nitride (TaN), titanium nitride (TiN), titanium-tungsten (TiW), tungsten (W), tungsten nitride (WN), titanium-titanium nitride (Ti—TiN), titanium silicon nitride (TiSiN), tungsten silicon nitride (WSiN), tantalum silicon nitride (TaSiN) and silicon nitride for encapsulating Cu. The use of such barrier metals to encapsulate Cu is not limited to the interface between Cu and the dielectric interlayer, but includes interfaces with other metals as well.

In conventional CMP techniques, a wafer carrier assembly is in contact with a polishing pad in a CMP apparatus. The wafers are typically mounted on a carrier or polishing head which provides a controllable pressure urging the wafers against the polishing pad. The pad has a relative movement with respect to the wafer driven by an external driving force. Thus, the CMP apparatus effects polishing or rubbing movement between the surface of each thin semiconductor wafer and the polishing pad while dispersing a polishing slurry containing abrasive particles in a reactive solution to effect both chemical activity and mechanical activity while applying a force between the wafer and a polishing pad. A different type of abrasive article from the above-mentioned abrasive slurry-type polishing pad is fixed abrasive article, e.g., fixed abrasive polishing pad. Such a fixed abrasive article typically comprises a backing sheet with a plurality of geometric abrasive composite elements adhered thereto.

It is extremely difficult to planarize a metal surface, particularly a Cu surface, as by CMP of a damascene inlay, with a high degree of surface planarity. A dense array of Cu features is typically formed in an interlayer dielectric, such as a silicon oxide layer, by a damascene technique wherein trenches are initially formed. A barrier layer, such as a Ta-containing layer e.g., Ta, TaN, is then deposited lining the trenches and on the upper surface of the silicon oxide interlayer dielectric. Cu or a Cu alloy is then deposited, as by electroplating, electroless plating, physical vapor deposition (PVD) at a temperature of about 50° C. to about 150° C. or chemical vapor deposition (CVD) at a temperature under about 200° C., typically at a thickness of about 8,000 Å to about 18,000 Å. CMP is then conducted to remove the Cu or Cu alloy overburden stopping on the barrier layer. Buffing is then conducted to remove the barrier layer, employing a mixture of a chemical agent and abrasive particles, leaving a Cu or the Cu alloy filling the damascene opening with an exposed surface. Overpolishing, as at about 10% to about 25%, is typically conducted beyond the time required to reach the targeted layer, as determined by conventional end point detection techniques, e.g., to completely remove the Cu or Cu alloy. For example, if 300 seconds of polishing are required to reach the interlayer dielectric, 20% overpolishing would involve a total polishing time of 360 seconds. Conventional CMP techniques employing polishing pads utilizing slurries containing abrasive particles as well as CMP techniques employing fixed abrasive articles are characterized by excessive dishing and sensitivity to overpolishing.

Dishing occurs wherein a portion of the surface of the inlaid metal of the interconnection formed in the groove in the interlayer dielectric is excessively polished resulting in one or more concavities or depressions. For example, adverting to FIG. 1, conductive lines 11 and 12 are formed by depositing a metal, such as Cu or a Cu alloy, in a damascene opening formed in interlayer dielectric 10, e.g., silicon dioxide. Subsequent to planarization, a portion of the inlaid metal 12 is depressed by an amount D referred to as the amount of dishing. For example, dishing occurring in metal lines, such as Cu or Cu alloy metal lines having a width of about 50 microns, generally exceeds 1,000 Å with as little overpolish as about 5% to about 10%.

Another phenomenon resulting from conventional planarization techniques is known as erosion which is characterized by excessive polishing of the layer not targeted for removal. For example, adverting to FIG. 2, metal line 21 and dense array of metal lines 22 are inlaid in interlayer dielectric 20. Subsequent to planarization, excessive polishing of the interlayer material results in erosion E.

Dishing disadvantageously results in a non-planar surface that impairs the ability to print high resolution lines during subsequent photolithographic steps. Dishing can also cause the formation of short circuits or open circuits in the metal interconnection formed thereover. Moreover, dishing increases when overpolishing is conducted to ensure complete removal of the metal layer and/or barrier layer across the wafer surface.

There exists a need for a polishing composition enabling the planarization of inlaid metal, particularly inlaid Cu metallization, with reduced dishing and insensitivity to overpolishing.

### DISCLOSURE OF THE INVENTION

An aspect of the present invention is a polishing composition suitable for planarizing metals, such as Cu and Cu alloys, with significantly reduced dishing and significantly reduced sensitivity to overpolish.

According to the present invention, the foregoing and other aspects are achieved in part by a composition for chemical mechanical polishing (CMP) a surface containing a metal, the composition comprising: one or more chelating agents; one or more oxidizers, one or more corrosion inhibitors; one or more acids; and deionized water.

Embodiments of the present invention comprise a polishing composition having a low static etching rate with respect to Cu. Embodiments of the present invention include polishing compositions comprising one or more chelating agents, such as ethylenediaminetetraacetic acid, ethylenediamine or methylformamide, one or more oxidizers, such as hydrogen peroxide, ferric nitrate or an iodate, one or more corrosion inhibitors, such as benzotriazole, mercaptobenzotriazole or 5-methyl-1-benzotriazole, one or more acids, such as an inorganic or organic acid sufficient to achieve a pH of about 3 to about 10, such as a pH of about 5 to about 8 e.g., acetic acid, phosphoric acid or nitric acid, the remainder deionized water.

Additional aspects of the present invention will become readily apparent to those skilled in this art from the following detailed description, wherein embodiments of the present invention are described, simply by way of illustration of the best mode contemplated for carrying out the present invention. As will be realized, the present invention is capable of other and different embodiments, and its several details are capable of modifications in various obvious respects, all without departing from the present invention. Accordingly, the drawings and description are to be regarded as illustrative in nature, and not as restrictive.

### BRIEF DESCRIPTION OF DRAWINGS

FIG. 1 schematically illustrates the phenomenon of dishing.

FIG. 2 schematically illustrates the phenomenon of erosion.

FIGS. 3-5 schematically illustrate sequential phases of a method employing a composition in accordance with an embodiment of the present invention.

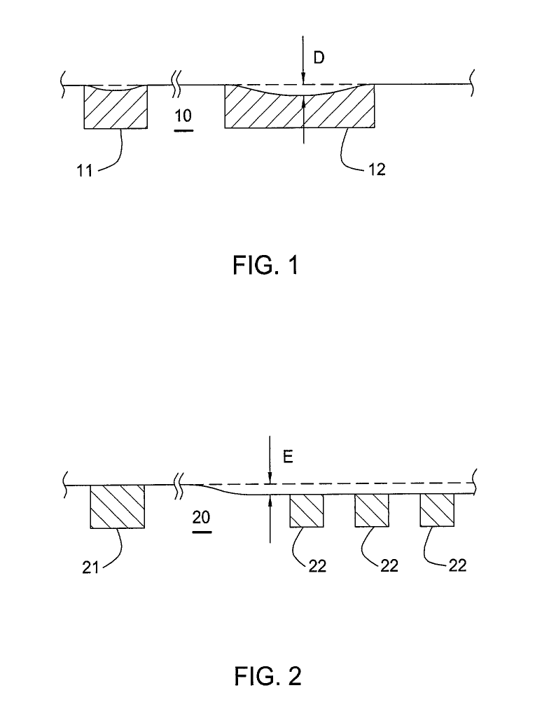

### DESCRIPTION OF THE INVENTION

The present invention provides a polishing composition that enables effective and efficient planarization of metallization, e.g., Cu metallization, with significantly reduced dishing and significantly reduced overpolishing sensitivity. Such disadvantages include the impairment of the ability to print high resolution lines during photolithographic processing and the formation of shorts or open circuits in the interconnection formed thereover. As used throughout this disclosure, the symbol Cu is intended to encompass high purity elemental copper as well copper-based alloys, e.g., copper-based alloys containing at least about 80 at. % copper.

The aspects of the present invention are achieved with a polishing composition strategically formulated such that it exhibits a reduced static etching rate, i.e., etching rate in the absence of mechanical abrasion, even at elevated temperatures, thereby reducing dishing. In addition, it was found that polishing compositions in accordance with the present invention advantageously generate polishing by-products which are not only smaller than abrasives applied during conventional CMP and fixed abrasive CMP but also relatively softer and, hence, provide a smooth and stable polish and a finished surface which exhibits reduced defects.

Conventional slurries for conventional CMP methodology as well as polishing compositions for fixed abrasive CMP methodology exhibit relatively high static etching rates and relatively high sensitivity to overpolishing, both of which lead to excessive dishing. The present invention overcomes problems attendant upon high dishing and high overpolishing sensitivity by providing polishing compositions formulated with a relatively low static etching rate for a particular material undergoing CMP. For example, conventional CMP methodology employing abrasive slurries exhibit a Cu static etching rate greater than 300 Å per minute at 52° C. and greater than 730 Å per minute at 52° C. for fixed abrasive copper CMP. Dishing in 50 micron conductive lines exceeds 1,000 Å with very little overpolish, e.g., about 5% to about 10%, for both conventional Cu CMP and fixed abrasive CMP.

In accordance with the present invention, polishing compositions are formulated that exhibit a static etching rate less than about 200 Å per minute at 52° C. Polishing compositions in accordance with the present invention enable CMP with dishing of 50 micron lines less than 520 Å even with as high as 30% to 50% overpolishing using fixed abrasive pads, and less than about 600 Å with 58% overpolishing using conventional pads.

In accordance with the present invention, polishing compositions suitable for use with abrasive-free copper CMP, conventional slurry copper CMP and fixed abrasive copper CMP comprise one or more chelating agents, such as a chelating agent containing one or more amine or amide groups, e.g., ethylenediaminetetraacetic, ethylenediamine or methylformamide. The chelating agents can be present in a suitable amount, such as about 0.2 wt. % to about 3.0 wt. %. The compositions in accordance with the present invention further comprise one or more oxidizers, one or more corrosion inhibitors, one or more acids and deionized water. The oxidizers can comprise any of various conventional oxidizers employed in CMP, such as hydrogen peroxide, ferric nitrate or an iodate, and can be present in a suitable amount, such as about 0.5 wt. % to about 8.0 wt. %. The corrosion inhibitors can comprise any various organic compounds containing one or more azole groups, such as benzotriazole, mercaptobenzotriazole, or 5-methyl-1-benzotriazole, and can be present in a suitable amount, such as about 0.02 wt. % to about 1.0 wt. %. The acid or acids are present in an amount for adjusting the pH of the composition to a range of about 3 to about 10 and can comprise any of various inorganic and/or organic acids, such as acetic acid, phosphoric acid, or oxalic acid. In formulating polishing compositions for use with conventional abrasive slurry-type CMP, conventional abrasive particles can be incorporated in a suitable amount up to about 40% wt. %, such as about 0.1 wt. % to about 40%, e.g., about 0.5 to about 30 wt. %.

Embodiments of the present invention comprise polishing compositions enabling CMP of Cu, without removing a barrier layer, and overpolishing, e.g., up to 50% and even longer.

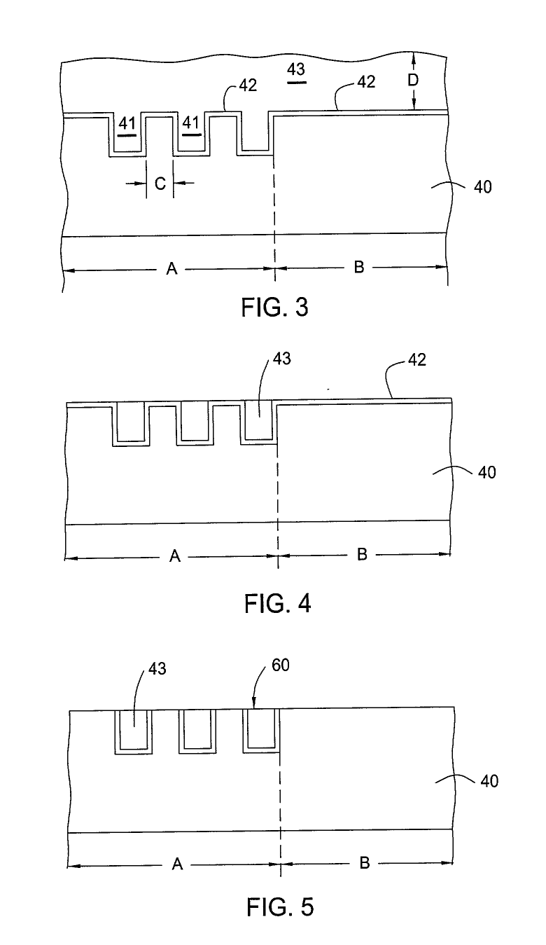

A CMP technique employing a polishing composition in accordance with an embodiment of the present invention is schematically illustrated in FIGS. 3-5, wherein similar features bear similar reference numerals. Adverting to FIG. 3, interlayer dielectric 40, e.g., silicon oxide, is formed overlying a substrate (not shown). A plurality of openings 41 are formed in a designated area A in which a dense array of conductive lines are to be formed bordering an open field B. A barrier layer 42, e.g., TaN, is deposited lining the openings 41 and on the upper surface of silicon oxide interlayer dielectric 40. Typically, the openings 41 are spaced apart by a distance C which is less than about 1 micron, e.g., about 0.2 micron. Cu layer 43 is then deposited at a thickness D of about 8,000 Å to about 18,000Å.

Adverting to FIG. 4, CMP is conducted employing an abrasive-free polishing composition in accordance with the present invention to remove the Cu overburden stopping on TaN barrier layer 42, employing a conventional end point detection technique, with significantly reduced dishing. As shown in FIG. 5, buffing is conducted to remove the barrier layer and reduce defects. The resulting Cu interconnection structure comprises a dense array A of Cu lines 43 bordered by open field B. The upper surface 60 of the Cu metallization exhibits significantly reduced dishing.

Polishing compositions in accordance with the present invention are applicable to planarizing a wafer surface during various stages of semiconductor manufacturing by any of various CMP techniques, including abrasive-free CMP, using any of various CMP systems and polishing articles, e.g., fixed abrasive- or abrasive slurry-type pads or sheets. The present invention enjoys particular applicability in the manufacture of high density semiconductor devices with metal features in the deep submicron range.

Only the preferred embodiment of the present invention and but a few examples of its versatility are shown and described in the present disclosure. It is to be understood that the present invention is capable of use in various other combinations and environments and is capable of changes and modifications within the scope of the inventive concept as expressed herein.

What is claimed is:

1. A composition for chemical mechanical polishing (CMP) a surface containing a metal, the composition having a static etching rate of no greater than about 200 Å per minute at about 52° C. and comprising:
one or more chelating agents;
one or more oxidizers;
one or more corrosion inhibitors;
one or more acids; and
deionized water.

2. The composition according to claim 1, wherein the metal is copper (Cu) or a Cu alloy.

3. The composition according to claim 2, having a pH of about 3.0 to about 10.0.

4. The composition according to claim 3, comprising:
about 0.2 to about 3.0 wt. % of one or more chelating agents;
about 0.5 to about 8.0 wt. % of one or more oxidizers;
about 0.02 to about 1.0 wt. % of one or more corrosion inhibitors;
an amount of acid sufficient to achieve a pH of about 3.0 to about 10.0; and
the remainder deionized water.

5. The composition according to claim 4, comprising:
at least one chelating agent having at least one amine or amide group;
at least one oxidizer comprising hydrogen peroxide, ferric nitrate or an iodate;
at least one corrosion inhibitor comprising at least one azole group; and
at least one inorganic or organic acid.

6. The composition according to claim 5, comprising:
ethylenediaminetetraacetic acid, ethylenediamine or methylformamide as a chelating agent;
benzotriazole, mercaptobenzothiazole or 5-methyl-1-benzotriazole as a corrosion inhibitor; and
acetic acid, phosphoric acid, or oxalic acid as an acid.

7. The composition according to claim 3, further comprising up to about 40 wt. % of abrasive particles.

8. The composition according to claim 7, comprising about 0.5 to about 30 wt. % of abrasive particles.

9. A composition for chemical mechanical polishing (CMP) a surface containing a metal, the composition having a pH of about 3.0 to about 10.0 and comprising:
one or more chelating agents;
one or more oxidizers;
one or more corrosion inhibitors;
one or more acids; and
deionized water.

10. The composition according to claim 9, having a static etching rate of no greater than about 200 Å per minute at about 52° C.

11. The composition according to claim 9, wherein the metal is copper (Cu) or a Cu alloy.

12. The composition according to claim 9, comprising:
about 0.2 to about 3.0 wt. % of one or more chelating agents;
about 0.5 to about 8.0 wt. % of one or more oxidizers;
about 0.02 to about 1.0 wt. % of one or more corrosion inhibitors;
an amount of acid sufficient to achieve a pH of about 3.0 to about 10.0; and
the remainder deionized water.

13. The composition according to claim 9, comprising about 0.5 to about 30 wt. % of abrasive particles.

14. A composition for chemical mechanical polishing (CMP) a surface containing a metal, the composition and comprising:
about 0.2 to about 3.0 wt. % of one or more chelating agents;
about 0.5 to about 8.0 wt. % of one or more oxidizers;
about 0.02 to about 1.0 wt. % of one or more corrosion inhibitors;
an amount of acid sufficient to achieve a pH of about 3.0 to about 10.0; and
the remainder deionized water.

15. The composition according to claim 14, having a static etching rate of no greater than about 200 Å per minute at about 52° C.

16. The composition according to claim 14, wherein the metal is copper (Cu) or a Cu alloy.

17. The composition according to claim 14, comprising:
ethylenediaminetetraacetic acid, ethylenediamine or methylformamide as a chelating agent;
benzotriazole, mercaptobenzothiazole or 5-methyl-1-benzotriazole as a corrosion inhibitor; and
acetic acid, phosphoric acid, or oxalic acid as an acid.

18. The composition according to claim 14, further comprising up to about 40 wt. % of abrasive particles.
